(19) United States
(12) Patent Application Publication
(10) Pub. No.: US 2009/0005245 A1
(43) Pub. Date: Jan. 1, 2009

(54) Manufactured seed having a live end seal coating

(75) Inventors: William C. Carlson, Olympia, WA (US); Antony R. Shoaf, Lexington, NC (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 12/164,684

(22) Filed: Jun. 30, 2008

Related U.S. Application Data
(60) Provisional application No. 60/947,032, filed on Jun. 29, 2007.

(51) Int. Cl. A01N 25/26

(52) U.S. Cl. 504/100

(57) ABSTRACT

An artificial seed is provided. The artificial seed includes a seed shell having a cavity sized and configured to receive an embryo. The artificial seeds also includes a live end seal and a tertiary seal. The live end seal is attached to the seed shell and is positioned to substantially seal the embryo within the seed shell. The tertiary seal is attached to the live end seal and includes a pesticide additive to inhibit at least bacterial growth on the tertiary seal.

### CROSS REFERENCE TO RELATED APPLICATION

The present application claims the benefit of U.S. Provisional Application No. 60/947,032, filed Jun. 29, 2007.

### FIELD OF THE INVENTION

The present disclosure relates generally to artificial seeds and, more particularly, to coatings for a live end seal attached to an artificial seed.

### BACKGROUND OF THE INVENTION

Asexual propagation of plants has been shown for some species to yield large numbers of genetically identical embryos, each having a capacity to develop into a normal plant. Such embryos are usually further cultured under laboratory conditions until they reach an autotrophic “seedling” state characterized by an ability to produce its own food via photosynthesis, resist desiccation, produce roots able to penetrate soil, and fend off soil microorganisms. Some researchers have experimented with the production of artificial seeds, known as manufactured seeds, in which individual plant somatic or zygotic embryos are encapsulated in a seed coat. Examples of such manufactured seeds are disclosed in U.S. Pat. No. 5,701,699, issued to Carlson et al., the disclosure of which is hereby expressly incorporated by reference.

Typical manufactured seeds include a seed shell, synthetic gametophyte and a plant embryo. A manufactured seed that does not include the plant embryo is known in the art as a “seed blank.” The seed blank typically is a cylindrical capsule having a closed end and an open end. The synthetic gametophyte is placed within the seed shell to substantially fill the interior of the seed shell. A longitudinally extending hard porous insert, known as a cotyledon restraint, may be centrally located within one end of the seed shell, surrounded by the synthetic gametophyte, and includes a centrally located cavity extending partially through the length of the cotyledon restraint.

The cavity is sized to receive the plant embryo therein. The well-known plant embryo includes a radicle end and a cotyledon end. The plant embryo is deposited within the cavity of the cotyledon restraint, cotyledon end first. The plant embryo is then sealed within the seed blank by an end seal. There is a weakened spot in the end seal to allow the radicle end of the plant embryo to penetrate the end seal.

In the past, the end seat is attached to the manufactured seed by either stretching a wax base film, such as Parafilm®, or forming a wax seal to enclose the embryo within the manufactured seed. Although such types of end seals are successful in sealing the embryo within the manufactured seed, they are not without their problems. As a non-limiting example, such end seals work well in laboratory conditions but can prematurely break when placed in more rigorous handling environments, such as agricultural sowers. Additionally, to protect against microbial invasion, such end seals have been treated with a tribiotic ointment. Such a treatment further reduces the strength of the end seal. Because the tertiary seal structurally degrades when exposed to predetermined environmental conditions, (e.g., it swells when hydrated) it allows the tertiary seal to become penetrable, thereby facilitating germination through both the primary and secondary end seals. Additionally, the tertiary seal is suitable as a carrier for pesticides that further protect the embryo prior to and during germination. As germination occurs through the tertiary seal, the pesticides remain functional as the tertiary seal is penetrated.

Currently, the artificial seed may be coated with an anti-microbial. In such cases, the anti-microbial applies an anti-microbial coating to the germinate as it penetrates the tertiary seal. Although effective, it has been discovered by the inventors of the present disclosure that such artificial seeds having an anti-microbial coating provide limited benefit in production.

As a non-limiting example, artificial seeds are often subjected to daily irrigation either in the form of rain or crop irrigation. In such instances, much of the available anti-microbial is lost to the surrounding soil long before the embryo begins germination. Even if an effective amount of anti-microbial remains after irrigation, the germinate often penetrates the tertiary seal at a non-perpendicular angle to the surface of the tertiary seal. Such penetration results in a gap between the germinate and the tertiary seal. This is undesirable as gapping creates a spacing wherein no anti-microbial is applied to the germinate, thereby defeating the purpose of an anti-microbial coating. Thus, there exists a need to inhibit bacterial growth on an end seal of an artificial seed.

### SUMMARY

An artificial seed is provided. In accordance with one embodiment of the present disclosure, such an artificial seed includes a seed shell having a cavity sized and configured to receive an embryo. The artificial seeds also includes a live end seal and a tertiary seal. The live end seal is attached to the seed shell and is positioned to substantially seal the embryo within the seed shell. The tertiary seal is attached to the live end seal and includes a pesticide additive to inhibit at least bacterial growth on the tertiary seal.

An artificial seed formed in accordance with the various embodiments of the present disclosure have several advantages over currently available manufactured seeds. In that regard, the pesticide additive inhibits bacterial growth on the tertiary seal thereby increasing survivability of the germinant.

### BRIEF DESCRIPTION OF THE DRAWINGS

The foregoing aspects and many of the attendant advantages of this disclosure will become better understood by reference to the following detailed description, when taken in conjunction with the accompanying drawings, wherein:

FIG. 1 is a cross-sectional side planar view of an artificial seed formed in accordance with one embodiment of the present disclosure, showing the artificial seed having a primary, secondary and tertiary seal;

FIG. 2 is a partial, cross-sectional side planar view of the artificial seed of FIG. 1 showing application of an antimicrobial agent to a germinating embryo as it penetrates the secondary and tertiary seals;

FIG. 3 is a side planar view of an alternate embodiment of the manufactured seed of FIG. 1, showing the tertiary seal applied to both the secondary end seal and sidewalls of the manufactured seed;

FIG. 4 is a cross-sectional, side planar view of an artificial seed constructed in accordance with still yet another alternate embodiment of the present disclosure;

FIG. 5 is a graphical representation of a preferred release of a pesticide additive in accordance with the present disclosure; and

FIG. 6 is a graph illustrating a percentage of a surface area of a tertiary seal having some bacteria growth as a function of a pesticide concentration.

### DETAILED DESCRIPTION OF THE PREFERRED EMBODIMENT

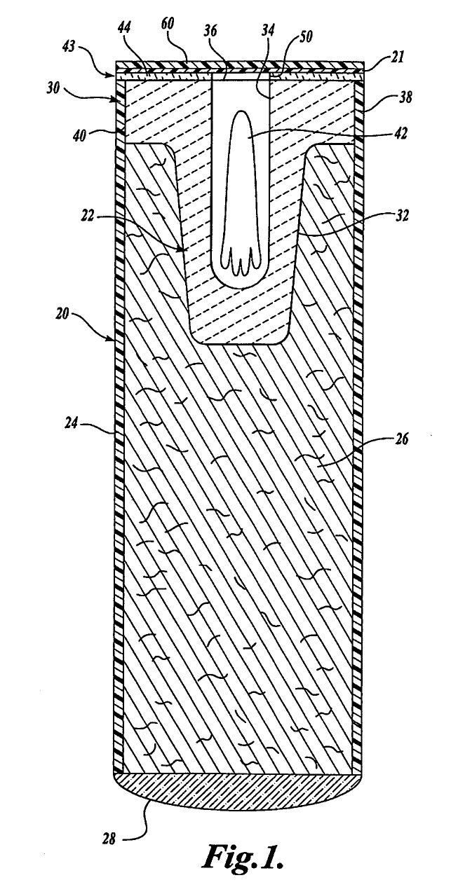

FIG. 1 illustrates an artificial seed 20 having a tertiary seal 60 constructed in accordance with one embodiment of the present disclosure. The artificial seed 20 includes a cylcap 22, a seed shell 24, a nutritive media 26, such as a gametophyte, and a dead end seal 28. The seed shell 24 is suitably formed from a section of tubular material. In one embodiment, the seed shell 24 is a sectioned straw of fibrous material, such as paper. The sections of straw may be pre-treated in a suitable coating material, such as wax.

In other embodiments, the seed shell 24 is formed from a tubular section of biodegradable, plastic material. One such material is a utilized polylatic acid (“PLA”) and is sold by NAT-UR of Los Angeles, Calif. Another material within the scope of the disclosure is a polycaprolactone (“PCL”) mixture, such as Dow Tone P-787 (Dow Chemical Co., Midland, Mich. 48647) with a 1% Tegomer H SI6440 plasticizer (Degussa Goldschmidt Chemical Corp, 914 East Randolph Road, Hopewell, Va. 23860).

Such biodegradable plastic tubes are similarly sectioned into appropriate lengths for a manufactured seed. Further, such biodegradable plastic tubes do not require a wax coating as such tubes are already resistive to environmental elements. It should be apparent that although sectioning tubes is preferred, other embodiments, such as obtaining tubes of appropriate size for use as manufactured seeds, are also within the scope of the present disclosure.

The cylcap 22, also known as a restraint, is suitably manufactured from a porous material having a hardness strong enough to resist puncture or fracture by a germinating embryo, such as a ceramic or porcelain material, and includes an end seal portion 30 and a cotyledon restraint portion 32. The cotyledon restraint portion 32 is suitably integrally or unitarily formed with the end seal portion 30. The cylcap 22 also includes a longitudinally extending cavity 34 extending through the end seal portion 30 and partially through one end of cotyledon restraint portion 32. The open end of the cavity 34 is known as a cotyledon restraint opening 36. The cavity 34 is sized to receive a plant embryo 42 therein.

In certain embodiments, as the cylcap 22 is suitably manufactured from a porous material, it may be desirable to coat the cylcap 22 with a barrier material to reduce the rate of water loss and restrict or reduce microbial entry. Such barriers include wax, polyurethane, glaze, nail polish, and a coating sold by Airproducts Airflex 4514.

The end seal portion 30 is suitably circular when viewed in a top planar view and includes sidewalls 38. Although circular is the preferred embodiment of the end seal portion 30, other embodiments and shapes, such as polygonal, square, triangular, oval and other shapes, are also within the scope of the present disclosure.

In the embodiment of FIG. 1, the sidewalls 38 are defined by the thickness of the end seal portion 30 and has a diameter substantially equal to the inside diameter of the seed shell 24. In certain embodiments, the cylcap 22 is bonded to the seed shell 24 by heat. As a non-limiting example, during manufacturing, the cylcap 22 may be heated to a predetermined temperature, such that when the seed shell 24 and the cylcap 22 are co-joined, heat transferred between the cylcap 22 and the seed shell 24 causes either the seed shell 24, the cylcap 22, or both to melt, thereby bonding the two together. In other embodiments, the cylcap 22 and the primary end seal 44 are first heat welded, then in a separate step the combined primary end seal-cylcap is reheated and the seed shell 24 is also heated and the two are joined. Other methods of bonding the cylcap 22 to the seed shell 24, such as a wax bond or a hot glue melt, are also within the scope of the present disclosure.

The sidewalls 38 may include a tapered portion 40. The tapered portion 40 may be a chamfer of one end of the end seal portion 30. The tapered portion 40 assists in assembling the cylcap 22 to the seed coat 24 during manufacturing. Although a tapered portion 40 is preferred, other embodiments, such as a cylcap that does not include a tapered portion, are also within the scope of the present disclosure. An embryo 42 is disposed within the cavity 34 and is suitably sealed therein by a live end seal 43.

The live end seal 43 includes a primary end seal 44 and a secondary end seal 21. The primary end seal 44 is suitably formed from a PCL material described above and includes a centrally located opening 50. The opening 50 is sized to correspond to diameter of the cavity 34 of the cylcap 22 to permit a germinating embryo 42 to pass therethrough. The primary end seal 44 is suitably attached to the end seal portion 30 by a variety of methods, including glue or heat bonding.

As a non-limiting example, the primary end seal 44 is mated to a pre-heated cylcap 22, such that the opening 50 is located above the cavity 34. The heat welds or bonds the primary end seal 44 to the cylcap 22. It should be apparent that the primary end seal 44 may be attached to the cylcap 22 before or after the cylcap 22 is attached to the seed shell 24. Also, if the seed shell 24 is constructed from PCL, it is desirable but not necessary that the melt temperature of the primary end seal 44 and the seed shell 24 be similar.

As another non-limiting example of attaching the primary end seal 44 to the cylcap 22, includes an adhesive gasket. In this example, the primary end seal 44 is heat sealed or bonded to the cylcap 22 with the opening 50 co-axially aligned with the cavity 34. In this process, a form is used to bend edges of the primary end seal 44 around the perimeter of the end seal portion 30 of the cylcap 22. If the melt temperature of the primary end seal 44 and the seed shell 24 are different, then a low bloom cyanoacrylate is used as an adhesive gasket to bond the primary end seal 44 and the seed shell 22.

Heat is applied after the glue and is done so as to thin the glue seal by melting incongruities that typically occur when manufacturing the seed shell 24 and forming the adhesive joint. Thereafter, the cylcap 22, including the primary end seal 44, is attached to the seed shell 24. As noted above, this method is also suitable to a cylcap 22 that is already attached to the seed shell 24. Finally, the foregoing method of attaching a primary end seal 44 to a seed shell 24 may be used for heat weld compatible or incompatible materials.

The secondary end seal 21 will now be described in greater detail. In that regard, the secondary end seal 21 is suitably formed from a well-known sealing material, such as Parafilm®. The secondary end seal 21 is formed and attached to the primary end seal 44 by a well-known method, such as heat bonding or gluing. In some embodiments, a sealing wax may be used to facilitate bonding between the PCL and the Parafilm. The secondary end seal 21 also includes a predetermined burst strength to permit a germinating embryo 42 to penetrate through the live end seal 44.

Still referring to FIG. 1, the tertiary seal 60 will now be described in greater detail. The tertiary seal 60 and live end seal 43, as used in the present embodiment, define an outer sealing layer and an inner sealing layer, respectively. Although the live end seal 43 has been described as including both a primary end seal 44 and a second end seal 21, it should be apparent that the disclosure is not intended to be so limited. As a non-limiting example, the live end seal 43 may include only the secondary end seal 21 and, therefore, such embodiments are also within the scope of the present disclosure.

The combination of the tertiary seal 60 and live end seal 43 creates a sealing surface, wherein the sealing layer, defined by the tertiary seal 60, is made from a predetermined material that degrades in structural integrity after a predetermined exposure to environmental conditions. The tertiary seal 60 also serves as an anti-microbial sealant to seal and protect around the embryo as the embryo germinates and emerges from within the seed shell 24 and protects the cotyledon restraint cavity. Suitable materials used to manufacture the tertiary seal 60 include water soluble materials, wax, environmentally degradable materials, and biodegradable materials. Thus, such materials, as well as materials equivalent in structure and properties, are within the scope of the present disclosure.

If the material used to manufacture the tertiary seal 60 is water soluble, it may include anti-microbial agents. As an example, a water soluble glue having prills of controlled release anti-microbial agents may be applied to the secondary end seal 21. The water soluble glue having flowable or wettable powder pesticides held in suspension within the glue is also within the scope of the present disclosure. In still yet another embodiment, the glue may include an adsorptive agent or carrier on which pesticides are adsorbed (e.g., charcoal or lignin). Also, a water soluble glue without an anti-microbial agent is within the scope of the present disclosure.

If a wax is used as the tertiary seal, it is desirable that the wax be of the type that is solid at sowing temperatures, and melts when exposed to a predetermined temperature, such as a mid-day seed zone temperature of between 25°-35° C. As still yet another example, the tertiary seal 60 may be manufactured from a polymer glue, such as H. B. Fuller PD 120, with filler or controlled release agent dispersed within. Such fillers within the scope of the present disclosure include activated charcoal, powdered lignin, fine sand and talc.

The tertiary seal 60 is also suitably manufactured from a hydroxypropylmethylcellulose. Other types of hydrophilic materials and cellulose-based coatings include cellulose acetate phthalate, hydroxypropylethylcellulose, ethylcellulose, methylcellulose, microcrystalline cellulose, and carrageenan. Such materials have the desired properties of having a relatively high structural integrity when dry and such structural integrity degrades when exposed to environmental conditions, such as water.

In certain embodiments, it is desirable to add an anti-microbial agent, such as Thiram 42S. Any anti-microbial agent that is substantially non-phytotoxic at the desired concentration is also within the scope of the present disclosure. As is described in greater detail below, a tertiary seal 60 treated with an anti-microbial agent is suitable as a carrier for pesticides to protect the embryo 42 prior to and during germination.

The break-through strength of the tertiary seal 60 is a function of the polymer used and the amount of it used to create the tertiary seal 60. As a non-limiting example, breaking strength was tested using a tertiary seal 60 manufactured from hydroxypropylmethylcellulose (HPMC) treated with Thiram 50WP as the anti-microbial agent. A test was conducted to determine the breaking strength of various mixtures. In that regard, a total of six treatments, as set forth below, were tested for break-through strength. A mixture of 2.64 g of HPMC 120 and 0.36 g HPMC 4000 was created for use in treatments 1 and 2.

Treatment 1 used a 0.91 g HPMC mix plus 0.4823 g Thiram and 8.61 ml of water, resulting in a 9.1% HPMC mix by weight.

Treatment 2 used 1.25 g HPMC mix plus 0.4823 g Thiram and 8.27 ml of water, resulting in 12.5% HPMC mix by weight.

Treatment 3 included 0.91 g HPMC 4000 plus 0.4823 g Thiram and 8.61 ml of water, resulting in 9.1% HPMC 4000 by weight.

Treatment 4 utilized 0.86 g HPMC 4000 plus 0.4823 g Thiram and 8.66 ml of water.

Treatment 5 utilized a mechanically disturbed lid attached to the seed.

Treatment 6 used a mechanically disturbed lid attached to the seed and then coated with a tribiotic ointment and left for 24 hours before testing. In this case, the secondary end seal has been slightly disturbed with an abrasion pad scrubber to allow the tertiary seal to be glued to the primary end seal.

Treatments 1-4 were done on top of the seed made as in treatment 6.

Twelve seeds per treatment were tested after coating and drying, and another twelve were tested 1 to 1.5 hours after they were rewetted with water. Table 1, set forth below, sets forth the results.

TABLE 1

| Treatment | 1 Dry | 1 Wet | 2 Dry | 2 Wet | 3 Dry | 3 Wet | 4 Dry | 4 Wet | 5 | 6 |
|---|---|---|---|---|---|---|---|---|---|---|
| Mean | 45.50 | 1.23 | 454.10 | 1.84 | 575.16 | 1.87 | 567.08 | 2.07 | 16.06 | 1.3 |
| Breaking | | | | | | | | | | |
| Strength (g) | | | | | | | | | | |
| Standard | 5.06 | 0.14 | 45.3 | 0.60 | 8.34 | 0.27 | 15.7 | 0.73 | 2.23 | 0.15 |
| Error | | | | | | | | | | |

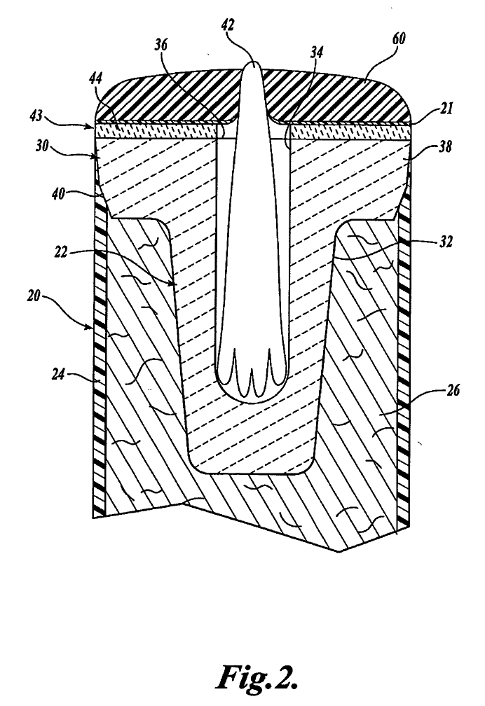

As may be best seen by referring to FIG. 2, as the embryo 42 germinates, it perforates both the live end seal 43 and tertiary seal 60. Because the tertiary seal 60 includes an anti-microbial agent, as the embryo 42 penetrates through the tertiary seal 60, a residue of the anti-microbial agent coats at least the sides of the embryo 42 during germination.

When the artificial seed 20 is handled and sowed, the tertiary seal 60 protects the live end seal 43 from damage associated with such activities. The tertiary seal 60 softens during irrigation following sowing to allow the live end seal 43 to break at the desired level during germination. The tertiary seal 60 softens when exposed to water due to the hydrophilic properties of the materials used to manufacture the tertiary seal 60. As a result, the structural integrity of the tertiary seal 60 degrades when exposed to various environmental conditions, while initially maintaining its structural integrity during handling and sowing.

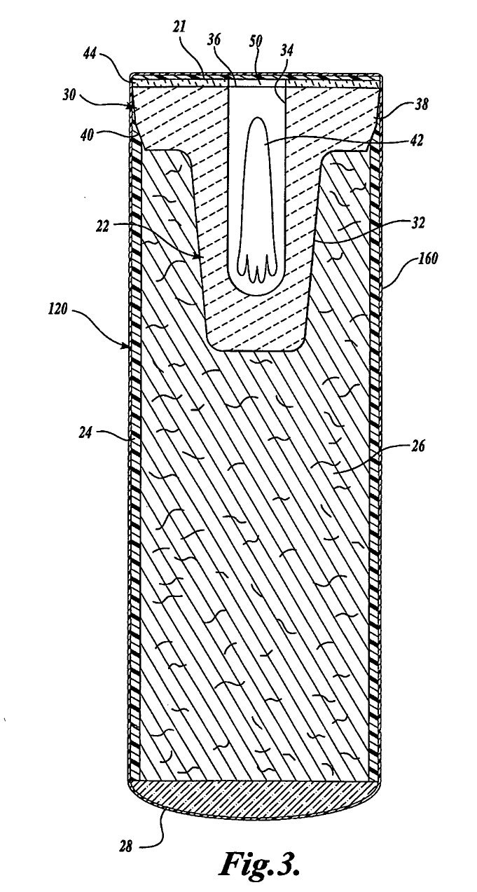

Referring to FIG. 3, an alternate embodiment of the artificial seed of FIGS. 1 and 2 will now be described in greater detail. The artificial seed 120 of FIG. 3 is substantially identical in materials and operation as the first embodiment described above, with the exception that the same material used to form the tertiary seal 160 is applied to the entire perimeter of the artificial seed. In that regard, after an artificial seed is assembled, a layer of hydrophilic material described above for the first embodiment may be applied to the entire outside surface of the artificial seed 120. Further, the hydrophilic material may include an anti-microbial agent, such as those described above.

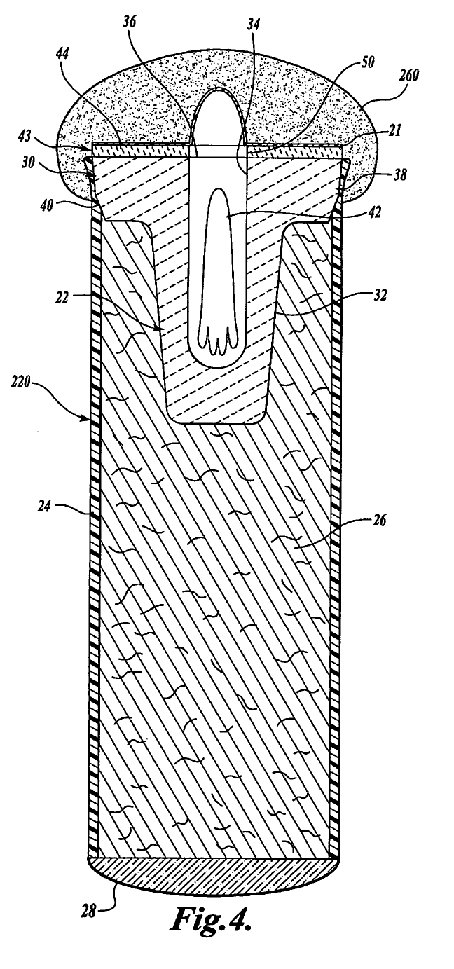

An artificial seed 220 constructed in accordance with still yet another embodiment of the present disclosure may be best understood by referring to FIGS. 4-6. The artificial seed 220 is substantially identical in materials in operation as the previous embodiments described above with the exception that it includes a tertiary seal 260 impregnated with a pesticide additive. Like reference numbers in FIGS. 4-6 refer to corresponding elements in the embodiments described above. Pesticide additives within the scope of the present disclosure include silver oxide (“Ag₂O”) and silver nitrate (“AgNO₃”), and related fungicides For example, the tertiary seal 260 is formulated from a composition that includes a vinyl acrylic copolymer, such as H. B. Fuller PD-124 (sold by H. B. Fuller PO Box 64683, St. Paul, Minn. 55164-0683), HPMC, activated charcoal, water, and silver oxide. In one non-limiting example, the tertiary end seal 260 is a composition that includes 3.3 g of PD-124, 62.7 g of water, 1.6 g of HPMC, 0.75 g of activated charcoal, and 0.6936 g of silver oxide. This composition includes the equivalent of 10 mg silver oxide per ml of tertiary end seal material (“TES”). It has been discovered by the current inventors that the composition used to manufacture the tertiary end seal 260 may include a pesticide additive between the ranges of 0.5 mg/ml TES and 135 mg/ml TES.

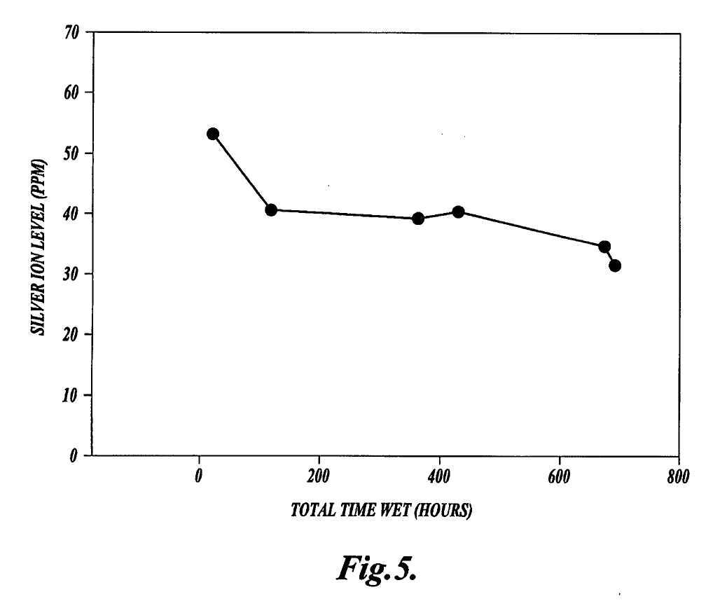

Artificial seeds 220 having microencapsulated pesticide additives are also within the scope of the present disclosure. As an example, microencapsulating silver oxide is one method of creating a controlled release chemical to provide a desired release of the pesticide additive during the germination period of an embryo 42 dispose within the artificial seed 220. One such controlled released pattern is illustrated in FIG. 5. Microencapsulation is well-known to one of ordinary skill in the art.

The inclusion of a pesticide additive to the tertiary seal chemistry has been discovered by the current inventors to inhibit fungal and bacterial growth on the tertiary seal 260. This is distinguished from the previous embodiments, wherein the anti-microbial coats the germinates during germination to apply a pesticide coating to the germinating embryo. The present inclusion of a pesticide additive to the tertiary seal chemistry inhibits actual fungal and bacterial growth on the tertiary seal, such that the germinates need not be necessarily coated with the pesticide to enhance survivability. The current inventors conducted an experiment to measure the inhibition of the invasion of tertiary seal material by microbes from soil or a potting mix.

In the experiment, potato dextrose agar was made up with either soil suspension using nursery soil or a mixture of peat/vermiculite/perlite potting mix commonly used in container growing plants. The medium included 19 g of potato dextrose broth and 12 g agar dissolved in 800 ml of water in an autoclave for 20 minutes and, thereafter, cooled in a water bath to 38° C. The soil agar suspension was made by adding 0.5 g of soil or potting mix to 80 ml sterilized water agar (1 g agar in 1,000 ml water) and shaken until it is well suspended. A 0.4 ml aliquot of soil suspension is placed onto a sterile Petri plate and then cooled.

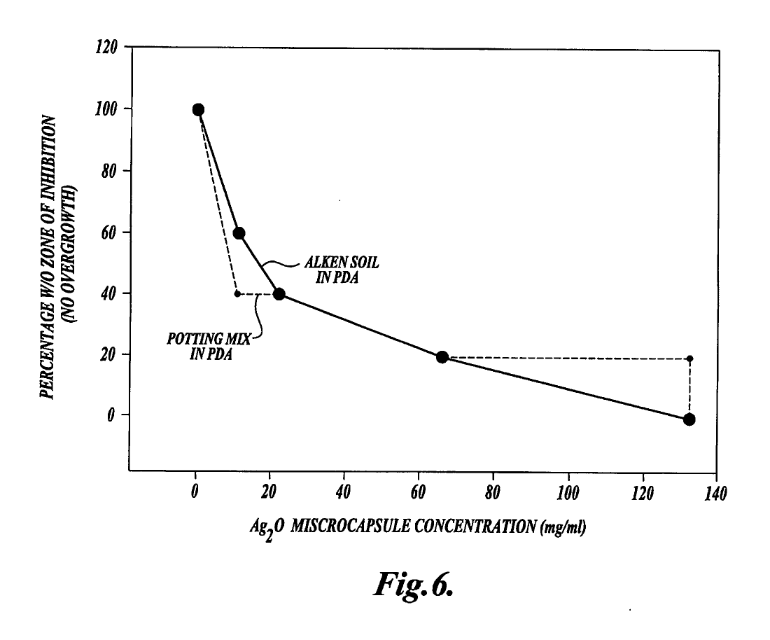

The chemistry, including a pesticide additive, used to make the tertiary seal was microencapsulated and thereafter placed on a wax paper sheet and dried. They were then lifted off the wax paper as dried disks and placed near the center of each Petri dish containing the inoculated medium. These Petri dishes were then placed in an incubator at 24° C. Periodically, the progression of infection on the plates and the tertiary seal material was scored. FIG. 6 is a plot of the resulting data results.

Thus, it has been surprisingly discovered by the inventors of the present disclosure that the addition of a pesticide additive to the tertiary seal chemistry resulted in an inhibition of fungal and bacteria overgrowth on the resulting tertiary seal 260. The benefit of keeping inoculums from growing on the tertiary end seal material results in a germinant having enhanced survivability as it is isolated from potential infection. Although mixing a pesticide additive into the tertiary seal chemistry is preferred, it should be apparent that other mixings, such as mixing the pesticide additive into the nutritive media 26, are also within the scope of the present disclosure.

While the preferred embodiment of the disclosure has been illustrated and described, it will be appreciated that various changes can be made therein without departing from the spirit and scope of the disclosure.

The embodiments of the disclosure in which an exclusive property or privilege is claimed are defined as follows:

1. An artificial seed, comprising:
(a) a seed shell having a cavity sized and configured to receive an embryo;
(b) a live end seal attached to the seed shell and positioned to substantially seal the embryo within the seed shell; and
(c) a tertiary seal attached to the live end seal, the tertiary seal including a pesticide additive to inhibit at least bacterial growth on the tertiary seal.

2. The artificial seed of claim 1, wherein the pesticide additive is Ag₂O.

3. The artificial seed of claim 1, wherein the pesticide additive is AgNO₃.

4. The artificial seed of claim 1, wherein the pesticide additive is microencapsulated to provide a controlled release of the pesticide additive.

5. An artificial seed, comprising:
(a) a seed shell;
(b) a restraint disposed within the seed shell and having a cavity housing an embryo;
(c) a primary end seal attached to one end of the seed shell;
(d) a secondary end seal disposed over the primary end seal; and
(e) a tertiary seal attached to the secondary end seal, the tertiary seal, comprising a vinyl acrylic copolymer, a hydroxypropylmethylcellulose, an activated charcoal, and a pesticide additive.

6. The artificial seed of claim 5, wherein the pesticide additive is Ag₂O.

7. The artificial seed of claim 5, wherein the pesticide additive is AgNO₃.

8. The artificial seed of claim 5, wherein the pesticide additive is microencapsulated to provide a controlled release of the pesticide additive.

9. The artificial seed of claim 8, wherein the pesticide additive is Ag₂O.

10. The artificial seed of claim 8, wherein the pesticide additive is AgNO₃.
